(19) United States
(12) Patent Application Publication
(10) Pub. No.: US 2017/0329477 A1
(43) Pub. Date: Nov. 16, 2017

(54) INTERACTIVE GLANCEABLE INFORMATION

(71) Applicant: Microsoft Technology Licensing, LLC., Redmond, WA (US)

(72) Inventors: Vignesh Sachidanandam, Seattle, WA (US); Hiroshi Tsukahara, Bellevue, WA (US)

(73) Assignee: Microsoft Technology Licensing, LLC., Redmond, WA (US)

(21) Appl. No.: 15/156,221

(22) Filed: May 16, 2016

(51) Int. Cl. G06F 3/0484; G06F 17/30

(52) U.S. Cl. CPC G06F 3/0484; G06F 17/30867

(57) ABSTRACT

A glanceable, interactive user interface for displaying prioritized relevant information is provided. User interaction efficiency is improved by prioritizing and providing relevant information to a user arranged in an abbreviated format for glanceable viewing. The user is enabled to glance at the display and quickly ascertain such information as: a current time, day, and date; upcoming events and meetings as they relate to the current time; incoming communications; and weather associated with a particular location. Additional details associated with the one or more prioritized information items can be displayed. When a user interacts with a displayed information item, the user interface is updated to display additional details. Through minimal user interaction, the user is enabled to receive on-demand progressive disclosure of additional details of selected information items.

### BACKGROUND

Many user interface displays are not particularly user-friendly with respect to how information relevant to a user is surfaced to the user. Accordingly, user efficiency is oftentimes compromised when trying to access relevant information. For example, viewing relevant information oftentimes requires various degrees of user interaction, such as unlocking a computing device, launching an application on the computing device, selecting or toggling user interface controls for viewing relevant information, etc. On some computing devices, a lock screen may be provided that proactively surfaces some relevant information; however, this information is often lost, for example, amongst less-relevant information, or requires additional effort or interaction from the user to access pieces of key information, such as the current time/date, incoming communication count, current weather, weather forecast, overview of upcoming events, type of upcoming events, time until a next event, etc. Accordingly, when users are unable to efficiently access relevant information, or when relevant information is not clearly distinguishable from less important information, users can become frustrated with their user interaction experience. In some cases, users can be unprepared for or even forget about upcoming events, for example, when unable to efficiently and clearly view calendar information or incoming communications.

Further, as society becomes increasingly mobile, individuals are increasingly using mobile computing devices, such as mobile phones and wearable mobile devices (e.g., smart watches, bracelets), for performing various computing tasks. Such devices are designed to provide the user ready access to information. Accordingly, users desire the ability to quickly and easily read information from the device. Additionally, such mobile computing devices have limited screen real estate, which constrains the amount and type of information that can be displayed. Thus, providing users with enough relevant information to help the users to easily know relevant information about their day in a glanceable view can be challenging.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Aspects are directed to a device, method, and computer-readable medium for improving user interaction efficiency by generating a glanceable, interactive user interface for displaying prioritized information. A glanceable information manager receives and prioritizes one or more information items for display to a user. Graphical representations of the one or more prioritized information items are arranged in a graphical user interface, enabling the user to glance at a display and quickly ascertain such information as: a current time, day, and date; upcoming events and meetings as they relate to the current time; incoming communications; and weather associated with a particular location. According to an aspect, additional details associated with the one or more prioritized information items can be displayed. In some examples, additional details are provided in graphical features. In other examples, additional details are provided in textual features. In some examples, additional details associated with a prioritized information item are exposed in response to a user interaction. For example, a default display may include an overview of the user's day, and through user interaction, the user is enabled to receive on-demand progressive disclosure of additional details of selected information items.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 is a simplified block diagram illustrating an example environment in which generating a glanceable, interactive user interface for displaying prioritized relevant information may be implemented;

FIGS. 2A and 2B are illustrations of example user interface display in a rest state;

FIG. 3 is an illustration of an example user interface display in a first interactive state;

FIG. 4 is an illustration showing user interaction with a displayed information item;

FIG. 5 is an illustration of example user interface display in a second interactive state;

FIG. 6 is another illustration of an example user interface display in a second interactive state;

FIG. 7 is an illustration of an example user interface display showing details provided by the user interface;

FIG. 8 is an illustration of an example user interface display showing a prioritization of communications information;

FIGS. 9A-B are illustrations of an example user interface display showing a prioritization of a next-occurring event and display of additional information associated with the next-occurring event in the user interface display;

FIGS. 10A-B are illustrations of an example user interface display showing a prioritization of an event and display of additional information associated with the event in the user interface display;

FIG. 11 is an illustration of an example user interface display showing a prioritization of a shorter-duration event over a full-day event for providing a display of additional information associated with the event in the user interface display;

FIG. 12 is an illustration of an example user interface display showing a display of additional information associated with a full-day event;

FIG. 13 is a flowchart showing general stages involved in an example method for generating a glanceable, interactive user interface for displaying prioritized relevant information;

FIG. 14 is a block diagram illustrating physical components of a computing device with which examples may be practiced;

FIGS. 15A and 15B are block diagrams of a mobile computing device with which aspects may be practiced; and

FIG. 16 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a device, method, and computer-readable medium for providing improved user interaction efficiency by providing a glanceable, interactive user interface for displaying prioritized relevant information. For example, a user interface for a computing device employs a glanceable information management system that prioritizes and displays information that is relevant to a particular user. Glanceable information is arranged such that the user can glance at the information on a display without requiring user interaction or further navigation. By eliminating extraneous user input by prioritizing and providing relevant information to the user via a glanceable, interactive user interface, wherein the user is enabled to progressively view additional details with minimal user interaction, user interaction efficiency is improved. Accordingly, an improved user experience is provided.

One example of a glanceable information item includes the current time and date. Another example of glanceable information items includes the user's upcoming events, for example, within a specified time scale (e.g., 12 hours, 24 hours). Another example of glanceable information includes an incoming communication count. Another example of a glanceable information item includes the current weather conditions in a designated region or city. Another example of a glanceable information item includes an amount of time until a next event on the user's calendar. The above examples are not limiting, and further examples of glanceable information are within the scope of the present disclosure. According to an aspect, a progressive disclosure of additional details associated with a prioritized information item are displayed on-demand in response to user interaction.

Glanceable information is particularly useful in computing devices that have limited viewing areas such as wearable devices (e.g., smartwatch device, bracelet), a mobile telephone, and the like. Although described here in the context of a smartwatch device system, it will be apparent that the teachings of the application have equal applicability to any other mobile or non-mobile devices, such as portable and desktop computers, personal digital assistants (PDAs), mobile phones, and the like. The use of a smartwatch is for illustrative purposes only to simplify the following discussion, and may be used interchangeably with “computing device”.

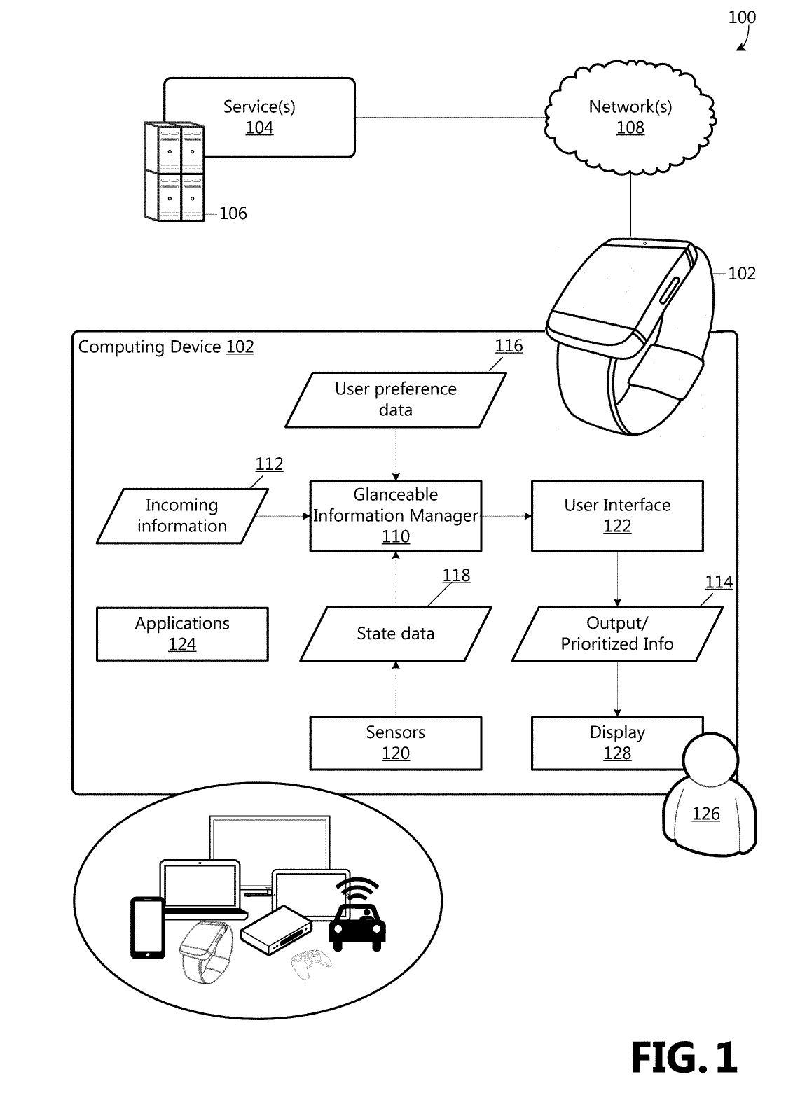

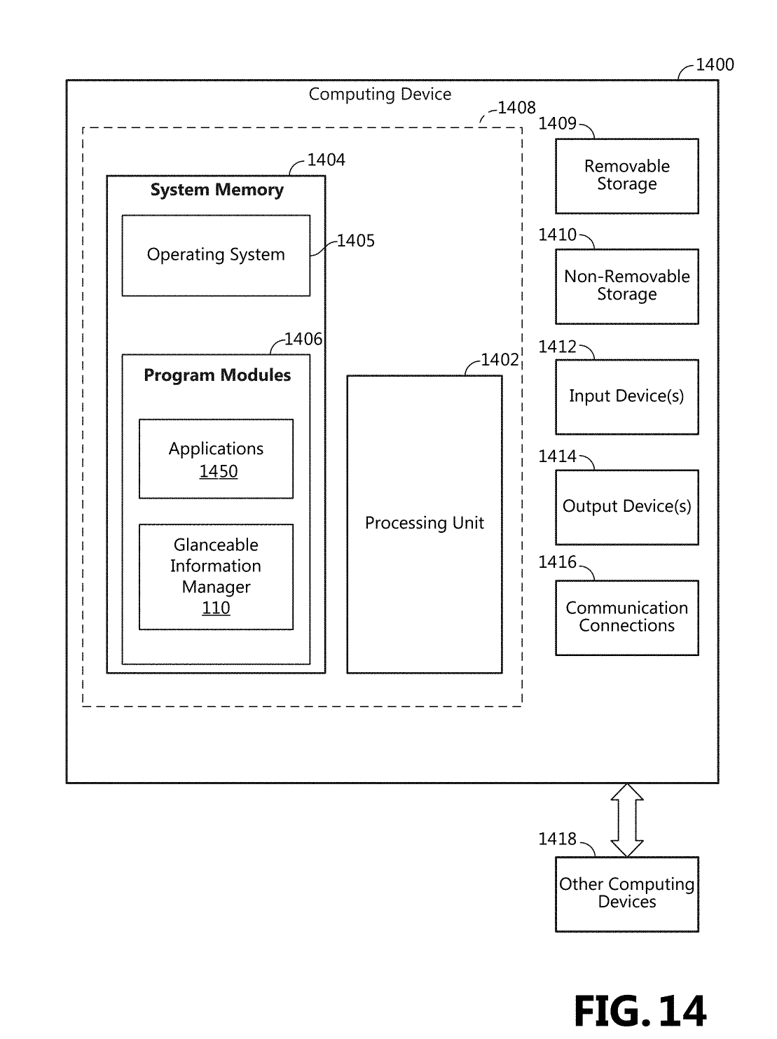

FIG. 1 illustrates a simplified block diagram of a representation of a computing environment 100 in which intelligent prioritization of relevant information for glanceable display may be implemented. As illustrated, the example environment includes a computing device 102. Although the computing device 102 in FIG. 1 is shown as a wearable device, the computing device can comprise other computing devices, such as a tablet computing device, a desktop computer, a mobile communication device, a laptop computer, a laptop/tablet hybrid computing device, a large screen multi-touch display, a gaming device, a smart television, a connected automobile, a smart home device, or other type of computing device. The hardware of these computing devices is discussed in greater detail in regard to FIGS. 14, 15A, 15B and 16.

One or more applications 124 can be executed on the computing device 102 for performing a variety of tasks, which may include, for example, to write, calculate, draw, take and organize notes, organize and prepare presentations, send and receive electronic communications (e.g., mail, messages, images), access web content, make music, and the like. Applications 124 may include thick client applications, which may be stored locally on the computing device 102, or may include thin client applications (i.e., web applications) that reside on a remote server and accessible over a network 108 or combination of networks, which include, for example and without limitation, a wide area network (e.g., the Internet), a local area network, a private network, a public network, a packet network, a circuit-switched network, a wired network, and/or a wireless network.

A thin client application may be hosted in a browser-controlled environment or coded in a browser-supported language and reliant on a common web browser to render the application executable on the computing device 102. In an example, an API server or a web server may be coupled to and provide programmatic or web interfaces respectively to one or more application servers 106. The one or more application servers 106 host one or more application services 104, which are operative to provide various functions and services to users who access the one or more application services 104. For example, the one or more application services 106 can comprise a mail service, a calendaring service, a weather service, a task list service, as well as various other services. In some examples, a wearable device, such as a smartwatch device, can be paired with another computing device, such as a mobile phone, via a wireless connection or wireless interconnection. For example, some applications and features may be utilized by the wearable device and stored on or provided by the mobile phone.

According to an aspect, the computing device 102 comprises a glanceable information manager 110, operative to process incoming information 112, for example, incoming information from the one or more application services 104, for prioritizing one or more relevant information items 114 to display to the user on a glanceable, interactive user interface display 128. In one example, incoming information 112 includes upcoming events and meetings based on one or more of the user's calendars. In another example, incoming information 112 includes incoming communications, such as emails, text messages, video or photo messages, etc. In another example, incoming information 112 includes current weather conditions and a weather forecast for a specified location, such as the user's current location or a location associated with an event or meeting on the user's calendar. The above examples are not limiting, and further examples of incoming information 112 are within the scope of the present disclosure.

In some examples, the glanceable information manager 110 is operative to prioritize incoming information 112 based at least in part on state data 118. As used herein, state data 118 includes user presence data that may be sensed by one or more of the computing device's sensors 120 or sensors that are employed by the computing device 102. For example, state data 118 may include such information as time of day, date, a current location of the computing device 102 (e.g., sensed by a global positioning satellite (GPS) system or based on cell tower signals), whether the device is moving (e.g., sensed by a GPS system, accelerometer), whether the device is connected to a network 108, what application 124 is being run, and so forth. In some examples, such as in examples where the computing device 102 is embodied as a wearable device (e.g., smartwatch, bracelet), state data 118 may additionally include attention data, such as information associated with how likely the user 126 is to notice output data 114 (e.g., whether the device is in close proximity to a surface, such as a portion of the user's body, whether the user 126 has lifted his/her wrist, such as to view the device's screen). Further state data 118 may include a current operating mode of the computing device 102 (e.g., ambient mode, interactive mode).

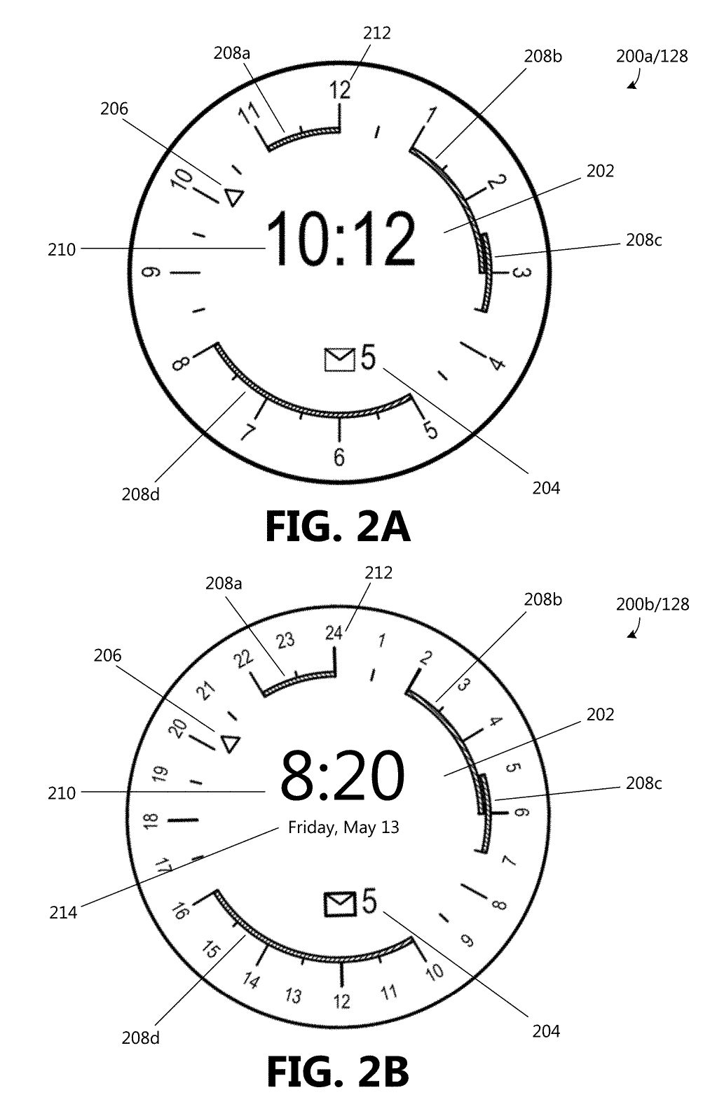

In some examples, the glanceable information manager 110 is operative to prioritize incoming information 112 based at least in part on user preference data 116. According to one example, user preference data 116 includes one or more user preferences manually set by the user 126 or preferences automatically provided as default settings, such as preferences associated with how information is presented (e.g., a display configuration, notification preferences, an amount of information to display, a time scale for which to display information), preferences associated with what type of information is provided (e.g., calendar events, email count, and current weather versus calendar events only versus only work-calendar events), preferences associated with a source of the information (e.g., work emails and calendar events vs personal emails and calendar events), etc. According to another example, user preference data 116 includes preferences learned by the system, for example, based on the user's 126 interaction with information presented to the user. Further aspects of prioritizing relevant information items 114 to include in an interactive user interface display 128 are described below with respect to example user interface displays 128 illustrated in FIGS. 2-12.

In some examples, the state data 118 and user preference data 116 are passed to a user interface 122 for generating the output 114. For example, the user interface 122 is operative to generate a user interface display 128 and update the user interface display based on state data 118 or user preference data 116. In accordance with aspects, the user interface 122 is operative to receive one or more relevant information items from the glanceable information manager 110, and generate visual, audible, or tactile representations of the relevant information for output via the computing device 102. For example, visual representations may be made visible to the user in the form of text, numbers, images, arcs, lines, or other graphical representations shown on a display 128 of the computing device 102. Graphical representations relevant information items are prioritized and arranged in a graphical user interface display 128 for enabling the user 126 to quickly ascertain relevant information, for example, via a glance at the display 128. According to an example, the user interface 122 is operative to generate and display visual representations of relevant information, such as: the current time, day, and date; upcoming events and meetings as they relate to the current time; incoming communications; location information, and weather associated with a particular location. According to an aspect, the user interface 122 is operative to generate a user interface display 128 including additional details associated with the one or more prioritized information items. In some examples, additional details are provided in graphical features, such as via a use of colors or opacities. In other examples, additional details are provided in textual features.

According to an aspect, the user interface 122 is further operative to receive an indication of user interaction with the display 128, and in response, update the user interface display 128 with additional details. For example, in response to a user interaction associated with a graphical representation of a relevant information item displayed on the computing device 102, the user interface 122 is operative to update the user interface display 128 with a progressive disclosure of additional details associated with the relevant information item. In one example, a progressive disclosure of additional details includes additional information about an upcoming meeting, such as information about a meeting organizer, meeting attendees, a meeting agenda, meeting location details (e.g., address, map), etc. In another example, a progressive disclosure of additional details includes providing a display of the contents of a communication, such as an email, text message, or video or photo message. In another example, a progressive disclosure of additional details includes providing additional weather details, such as a temporal-based forecast (e.g., hourly, 2-hours, 3-hours, daily), a radar map, sunrise or sunset information, etc.

As described above, the user interface 122 is operative to generate audible representations of the relevant information for output via the computing device 102. For example, audible representations may include computer-generated speech or other audio content played via speaker(s) of the computing device 102 or connected to the computing device. Also described above, the user interface 122 is operative to generate tactile representations of the relevant information. For example, tactile representations may be provided to the user in the form of a physical sensation, such as a tap, pulse, vibration, or pattern of taps, pulses, or vibrations, for example, produced by a piezoelectric actuator. The representations of relevant information are depicted as an output 114 that is directed to the user 126. Various examples of glanceable, interactive user interface displays 128 are illustrated in FIGS. 2-12, and further aspects of generating and updating the user interface display 128 are described below.

According to an aspect, the glanceable information manager 110 prioritizes relevant information items 114 for determining which information items to include at various states, for example, based on a current operating mode of the computing device 102. A first state, herein referred to as a rest state, may include a minimal amount of high level information, and a next state may include additional details of the high level information, as well as additional information. For example, a rest state may be associated with an ambient or sleep mode, where there may be little to no interaction with the computing device 102, and thus the device may power down various components to save power.

With reference now to FIGS. 2A and 2B, examples of user interface displays 128 in a rest state are illustrated. As illustrated, the rest state user interface display 200a,b (generally, 200) includes a central region 202, where one or more relevant information items are displayed. For example, the central region 202 may include one or more of: a current time 210, a current date 214, and a current incoming communication count 204. According to an aspect, a determination of which relevant information items to include in the central region 202 is made by the glanceable information manager 110. For example, the determination may be made based on user preference data 116, and more or fewer information items may be displayed.

The rest state user interface display 200a,b (generally, 200) further includes an area surrounding the central region 202 that provides information to the user 126 such as a current time 206, an overview of upcoming events 208a-d (generally, 208) in a given time scale 212, and an amount of time until a next event. The example rest state user interface display 200a illustrated in FIG. 2A includes an overview of upcoming events 208 in a 12-hour time scale 212, and the example rest state user interface display 200b illustrated in FIG. 2B includes an overview of upcoming events 208 in a 24-hour time scale 212. In other examples, other time scales 212 of information may be provided (e.g., 6-hour, 18-hour, 1-week). The time scale 212 is a circular or linear representation of hours (or days if the time scale is a 1-week scale). Depending on the shape of the user interface display 128, which is most-often dependent on the shape of the screen of the computing device 102, the representation of the time scale 212 may vary.

For example, on a circular user interface display 128, such as illustrated in FIGS. 2A and 2B, equally spaced indexes are provided along the periphery of the display according to the represented dimension of time (e.g., in 30-minute, 1-hour steps). In some examples, the indexes may be numbered, for example, 1 through 12, indicating the hours in a 12-hour cycle (as illustrated in FIG. 2A), or 1 through 24, indicating the hours in a 24-hour cycle (as illustrated in FIG. 2B). According to an example, a single hand, pointer, or other graphical representation indicates the current time 206 by making rotations around the time scale 212.

According to an aspect, upcoming events 208 are represented in the form of arcs circumferentially positioned along the time scale 212. Each arc is a graphical representation of an upcoming event 208, wherein the beginning point of the arc is representative of the start time of the event, the ending point of the arc is representative of the end time of the event, and the arc length is representative of the duration of the event. For example and with reference to the example illustrated in FIG. 2A, the current time 206/210 is shown as 10:12 as indicated by textual information in the central region 202 and by the pointer positioned between the 10:00 and 10:30 indexes. A first event 208a is shown as starting at 11:00, and ending at 12:00, a second event 208b is shown as starting at 1:00, and ending at 3:00, a third event 208c is shown as starting at 2:30, and ending at 3:30, and a fourth event 208d is shown as starting at 5:00, and ending at 8:00. As another example and with reference to the example illustrated in FIG. 2B, the current time 206/210 is shown as 8:20 (p.m.) as indicated by textual information in the central region 202 and by the pointer positioned between the 20:00 and 21:00 indexes. A first event 208a is shown as starting at 10:00 (p.m./20:00), and ending at 12:00 (a.m./00:00), a second event 208b is shown as starting at 2:00 (a.m.), and ending at 6:00 (a.m.), a third event 208c is shown as starting at 5:00 (a.m.), and ending at 7:00 (a.m.), and a fourth event 208d is shown as starting at 10:00 (a.m.), and ending at 4:00 (p.m./16:00).

By displaying the user's upcoming events 208 as arcs positioned along the time scale 212, the user 126 is enabled to quickly and easily get relevant information about his/her upcoming events and meetings as they relate to the current time 206. For example, by simply glancing at the user interface display 128/200, the user 126 is able to understand an overview of upcoming events 208 and the amount of time until his/her next meeting. As another example, on a square or rectangular-shaped user interface display 128, the time scale 212 may be represented as equally spaced indexes linearly positioned along the sides or periphery of the display according to the represented dimension of time, and the user's upcoming events 208 may be visually represented as lines positioned along the time scale 212.

According to an aspect, overlapping events are easily identifiable, for example, as indicated by overlapping arcs (or lines) positioned along the time scale 212. According to an aspect, the glanceable information manager 110 is operative to prioritize which upcoming events 208 to include in the user interface display 128/200. In one example, the glanceable information manager 110 prioritizes upcoming events 208 according to which of the user's calendars the event is received (e.g., a work calendar versus a personal calendar). In another example, the glanceable information manager 110 prioritizes upcoming events 208 according to a type of event (e.g., work event versus personal event). In another example, the glanceable information manager 110 prioritizes upcoming events 208 according to an importance level associated with the event, for example, as applied in the user's or the meeting organizer's calendar. In another example, the glanceable information manager 110 prioritizes upcoming events 208 according to whether the event is a full-day event versus a shorter-duration event (e.g., a birthday marked on the user's calendar versus a meeting). In another example, the glanceable information manager 110 prioritizes upcoming events 208, such as meetings, according to whether the user has accepted a meeting request associated with the meeting. For example, the glanceable information manager 110 may prioritize upcoming meetings that the user has accepted for inclusion in the user interface display 128/200. In another example, the glanceable information manager 110 prioritizes upcoming events 208 based on whether the user 126 has attended a same event in the past. For example, the user's calendar may include a recurring meeting that he/she never attends. Accordingly, the meeting may be ranked with a lower priority, and the glanceable information manager 110 may determine to not include the meeting in the user interface display 128/200. In another example, the glanceable information manager 110 prioritizes upcoming events 208 based on the user's location. For example, if an event is located more than a predetermined maximum distance from the user's current location, the glanceable information manager 110 may determine to not include the meeting in the user interface display 128/200. The above examples are not intended to be limiting, and other examples are within the scope of the present disclosure.

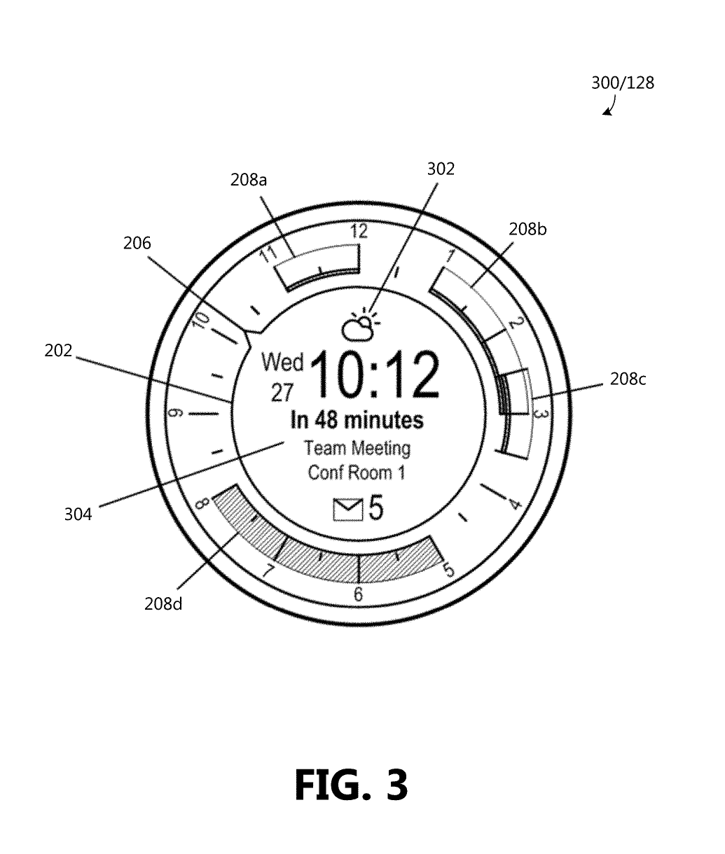

With reference now to FIG. 3, an example of a user interface display 128 in a first interactive state is illustrated. For example, when the computing device 102 is in a more interactive mode, such as when a sensor 120 receives an indication that the user 126 has lifted his/her wrist (e.g., to view the device's screen) or an indication that the user 126 has activated the device (e.g., via touch, voice, movement, or other input method), the user interface 122 is operative to update the user interface display 128 to an interactive state display such as the example interactive state display 300 illustrated in FIG. 3.

According to an aspect and as illustrated in FIG. 3, a second state, herein referred to as a first interactive state 300, includes a display of additional relevant information, such as one or more of: a graphical indication of which of the user's calendars that an upcoming event 208 is associated, information associated with the next upcoming event 304, and the current weather 302. In one example, the user interface 122 is operative to update the user interface display 128/300 to provide a visual differentiation between upcoming events 208 associated with different calendars. For example and as illustrated in FIG. 3, the user interface 122 may display upcoming events 208a,b,c from the user's work calendar in one color, and upcoming events 208d from the user's personal calendar in another color. In another example, the user interface 122 is operative to update the user interface display 128/300 to provide a visual differentiation between upcoming events 208 that are set as an item with high importance (or low importance), for example, as set by the user or the meeting organizer. In another example, the user interface 122 is operative to update the user interface display 128/300 to provide a visual differentiation between upcoming events 208, such as meetings, that the user has accepted. The above examples are not intended to be limiting, and other examples are within the scope of the present disclosure.

According to an example, the user interface 122 is operative to update the user interface display 128/300 to provide a first level of detail associated with a next upcoming event 304. For example, the user interface 122 may include information such as an amount of time until the next upcoming event 208, a subject of the next upcoming event, a location of the next upcoming event. As illustrated, the user interface 122 may display additional information in the central region 202. The user interface 122 may include more or less information based on various factors, such as an amount of space available on the display 128/300.

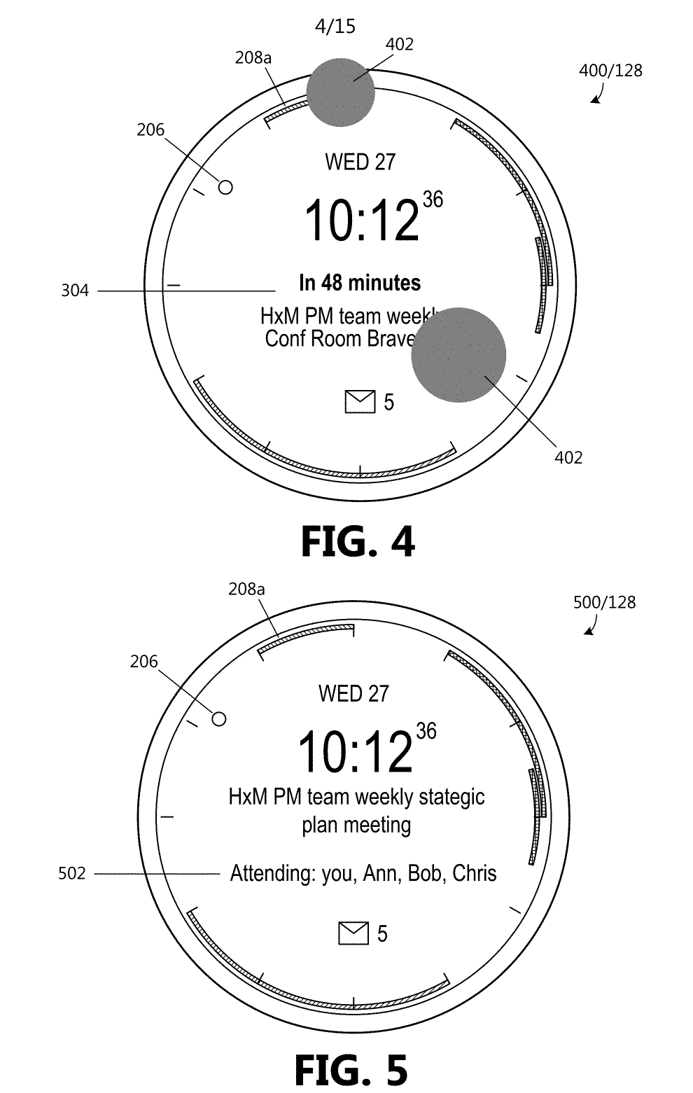

According to an example, the user interface 122 is operative to update the user interface display 128/300 to provide a first level of detail associated with the weather 302. For example, the user interface 122 is operative to provide a graphical representation of the weather 302 of a specified location, such as the user's current location or another location set by the user 126. According to an aspect and as illustrated in FIG. 4, the user interface 122 is operative to receive user input 402, such as an indication of a selection of a displayed information item or an indication to navigate to a next state or to a next display (e.g., via a touch, gesture, voice, selection of a hardware button, turning of a crown).

In response, and as illustrated in FIG. 5, the user interface 122 updates the user interface display to provide a next level of detail. According to an aspect, the user interface 122 updates the user interface display 128/500 to a third state, herein referred to as a second interactive state as illustrated in FIG. 5. In the second interactive state, the user interface 122 is operative to include a display of additional relevant information. According to examples, the additional relevant information provided in the second interactive state depends on the received user input. For example, when the user 126 selects a particular displayed information item, such as a representation of an upcoming event 208, the user interface 122 is operative to communicate with the glanceable information manager 110 to receive additional information associated with the selected upcoming event 208, and update the user interface display 128/500 to display at least a portion of the received additional information. In the illustrated example, the user interface display 128/500 is updated to display the attendees 502 of the meeting. Upon further user input 402, for example, a subsequent touch in the central region 202 or on the arc representing the event, or via a gesture or physical manipulation of a functionality control indicating to advance to a next left of detail, the user interface 122 is operative to update the user interface display with a next progressive disclosure of additional information.

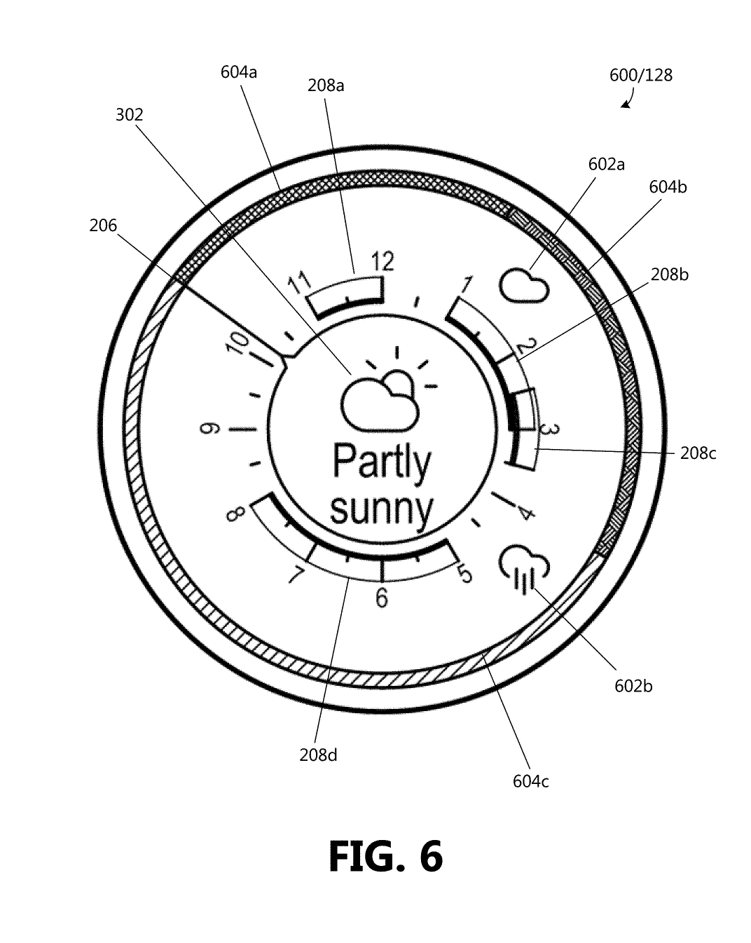

According to an example and with reference now to FIG. 6, the user interface 122 is operative to receive user input, such as an indication of a selection of a graphical representation of the weather 302, and in response, the user interface is operative to update the user interface display 128/600 to provide a next level of detail associated with the weather 302. For example, in response, the user interface 122 communicates with the glanceable information manager 110 to receive additional weather information, and updates the user interface display 128/600 provide the additional information, such as weather forecasts 602a-c (generally, 602) during the displayed time scale 212. According to one example, the user interface 122 is operative to receive and display weather forecasts 602 for a current time interval 604a and for time intervals 604b-c associated with upcoming events 208. In the illustrated example, the user interface 122 updates the user interface display 128/600 with the current weather 302 and with two weather forecasts 602a,b during three upcoming events 208b,c,d.

According to an example, the user interface 122 is operative to receive user input, such as an indication of a selection of a graphical representation of an incoming communication count 204. In response to a user interaction, such as a selection of the graphical representation of the incoming communication count 204, the user interface 122 is operative to communicate with the glanceable information manager 110 to receive additional communications information, and updates the user interface display 128 to provide the additional information, such as an indication of who the communications are from, what type of communications the user has received, or a display of the contents of the communications. The additional information may be provided progressively according to user interaction. As should be appreciated, interactive states provide additional on-demand information, such as about upcoming meetings, and an ability to dive deeper into other application service modules (e.g., mail, weather), thus allowing the user 126 to receive information associated with key changes in weather in the day and more details on missed communications.

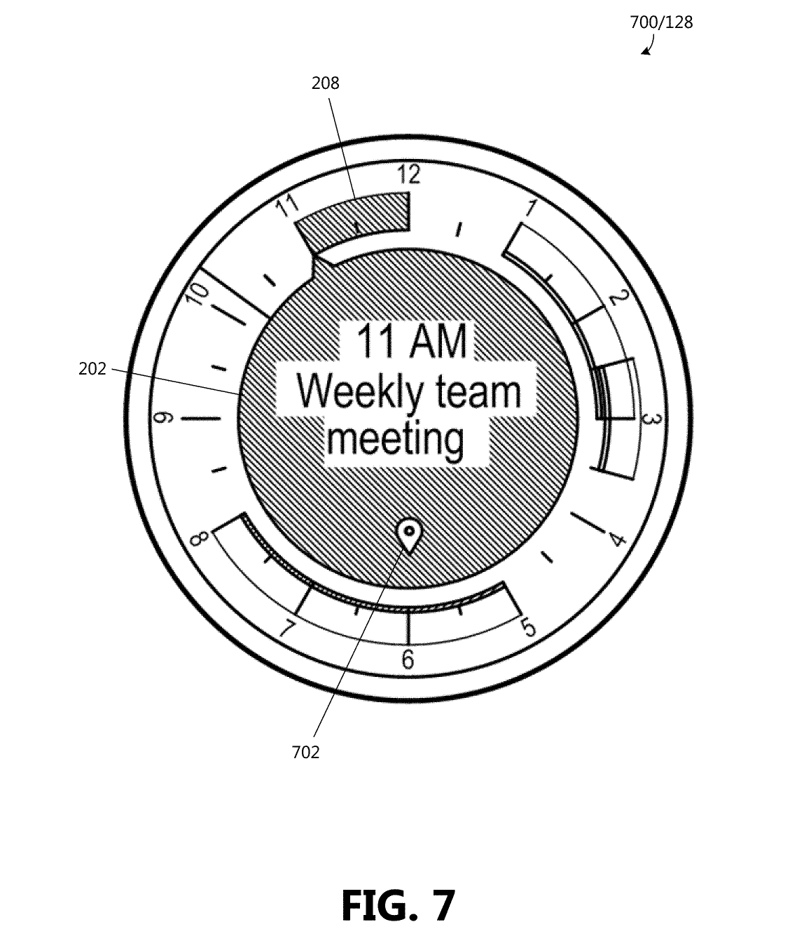

As described above, the user interface 122 is operative to utilize graphical features, such as via a use of colors or opacities to provide information associated with the one or more relevant information items. An example user interface display 128/700 shown in FIG. 7 illustrates a use of color by the user interface 122 to provide relevant information to the user 126. For example and as illustrated, the user interface 122 updates the user interface display 128/700 to color the central region 202 of the display to match a color used to represent an upcoming event 208. Accordingly, the user 126 is enabled to quickly see that the information provided in the central region 202 pertains to the like-colored upcoming event 208. Further illustrated in FIG. 7, the user interface 122 is operative to provide location information in the interface display 128/700. For example and as illustrated, the user interface 122 updates the user interface display 128/700 to include a graphical representation of a map marker 702, indicating to the user that he/she is at the location of the next upcoming event 208. Other location information may be provided, for example, a distance to the location of the next upcoming event 208, an estimated time to travel to the next upcoming event 208, a notification that in order to reach the location of the next upcoming event 208, the user 126 needs to leave his/her current location, etc.

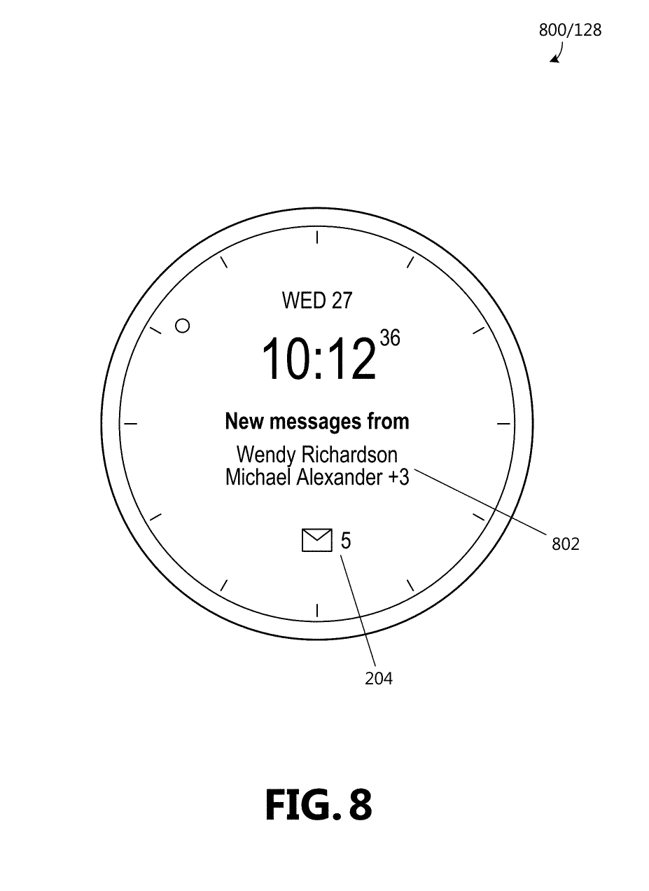

With reference now to FIG. 8, an example user interface display 128/800 including only communications information 204,802 is illustrated. As described above, the glanceable information manager 110 is operative to prioritize incoming information 112 for determining what information to present to the user 126. In a scenario where the user 126 does not have any upcoming events 208 within a displayed time scale 212 (e.g., within the next 12 hours, within the next 24 hours), the glanceable information manager 110 is operative to determine what information to display, for example, in the central region 202 in a first interactive state. As illustrated in FIG. 8, the glanceable information manager 110 may prioritize incoming communication information, and may prioritize and provide additional communication information, such as senders 802 associated with received communications.

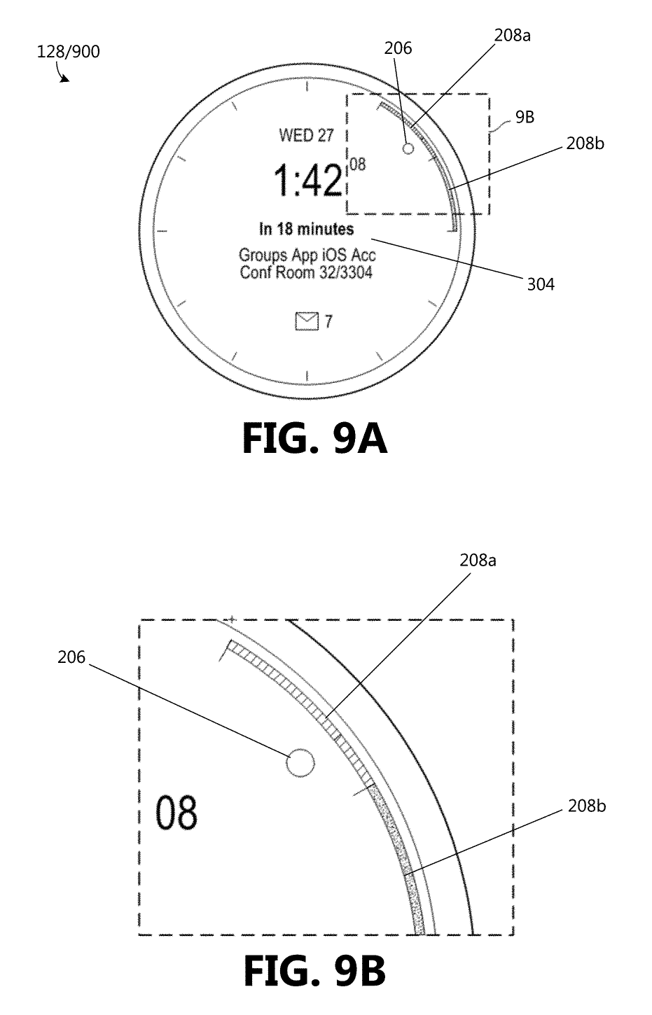

With reference now to FIGS. 9A-9B, illustrations are provided showing an example user interface display 128/900, wherein additional information 304 associated with a second event 208b is prioritized and displayed in the user interface display 128/900. For example and as shown example on the user interface display 128/900, the user 126 has two back-to-back meetings (e.g., events 208a, 208b), the first of which is currently occurring (e.g., the current time 206 is within the duration of the first event 208a). The glanceable information manager 110 is operative to prioritize one of the events 208a,b for display of the additional information in the user interface display 128/900. In some examples and as illustrated in FIG. 9A, the glanceable information manager 110 prioritizes a next-occurring upcoming event 208b over a currently-occurring event 208a for displaying the additional information 304.

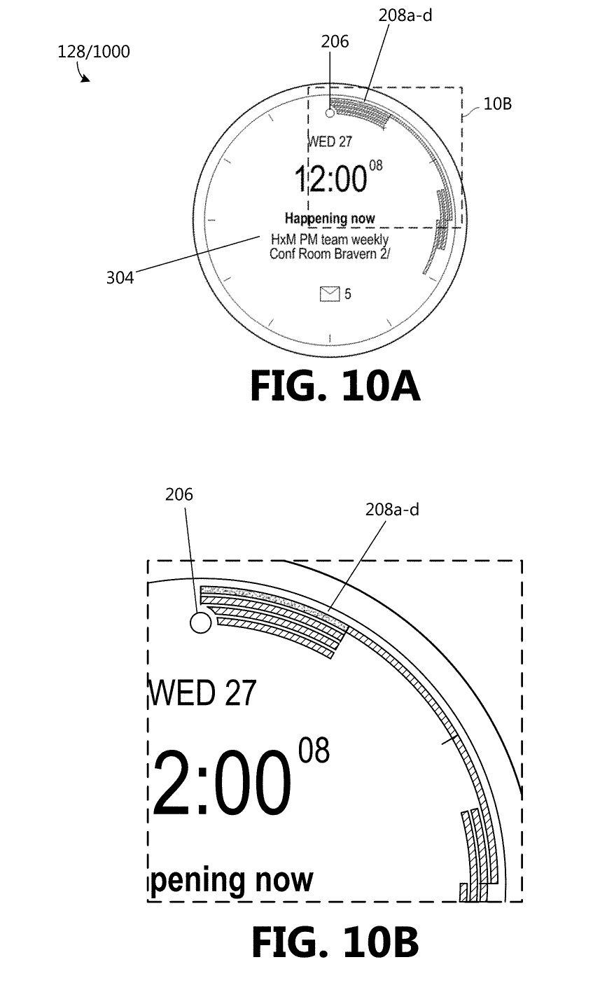

With reference now to FIGS. 10A-10B, an example user interface display 128/1000 showing a plurality of upcoming events 208a-d occurring at the same time is provided. As illustrated, the glanceable information manager 110 is operative to prioritize one of the events 208a-d, and additional information 304 the prioritized event is displayed in the central region 202 of the user interface display 128/1000. The glanceable information manager 110 may prioritize the event 208 based on one of: according to which of the user's calendars the event is received (e.g., a work calendar versus a personal calendar); according to a type of event (e.g., work event versus personal event); according to an importance level associated with the event, for example, as applied in the user's or the meeting organizer's calendar; according to whether the event is a full-day event versus a shorter-duration event (e.g., a birthday marked on the user's calendar versus a meeting); according to whether the user has accepted a meeting request associated with the meeting; based on whether the user 126 has attended a same event in the past; and based on the user's location.

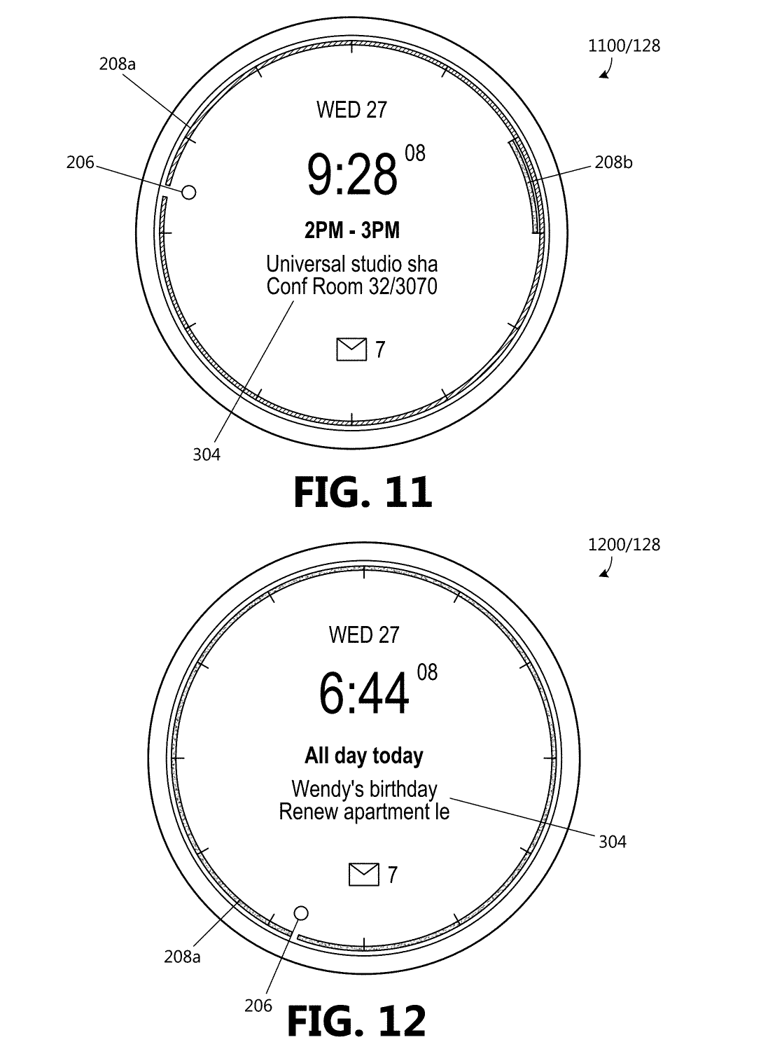

As mentioned above, in some examples, the glanceable information manager 110 prioritizes an event based on whether the event is a full-day event versus a shorter-duration event (e.g., a birthday marked on the user's calendar versus a meeting). With reference now to FIG. 11, an example user interface display 128/1100 is shown, wherein a shorter-duration event 208b is prioritized over a full-day event 208a for providing and displaying additional information 304 in the user interface display 128/1100. In some examples and as illustrated in FIG. 12, additional information 304 associated with a full-day event 208a may be displayed. For example and as illustrated in FIG. 12, in a scenario where the full-day event 208a is the only event within the displayed time scale 212, additional information 304 associated with the full-day event 208a may be displayed.

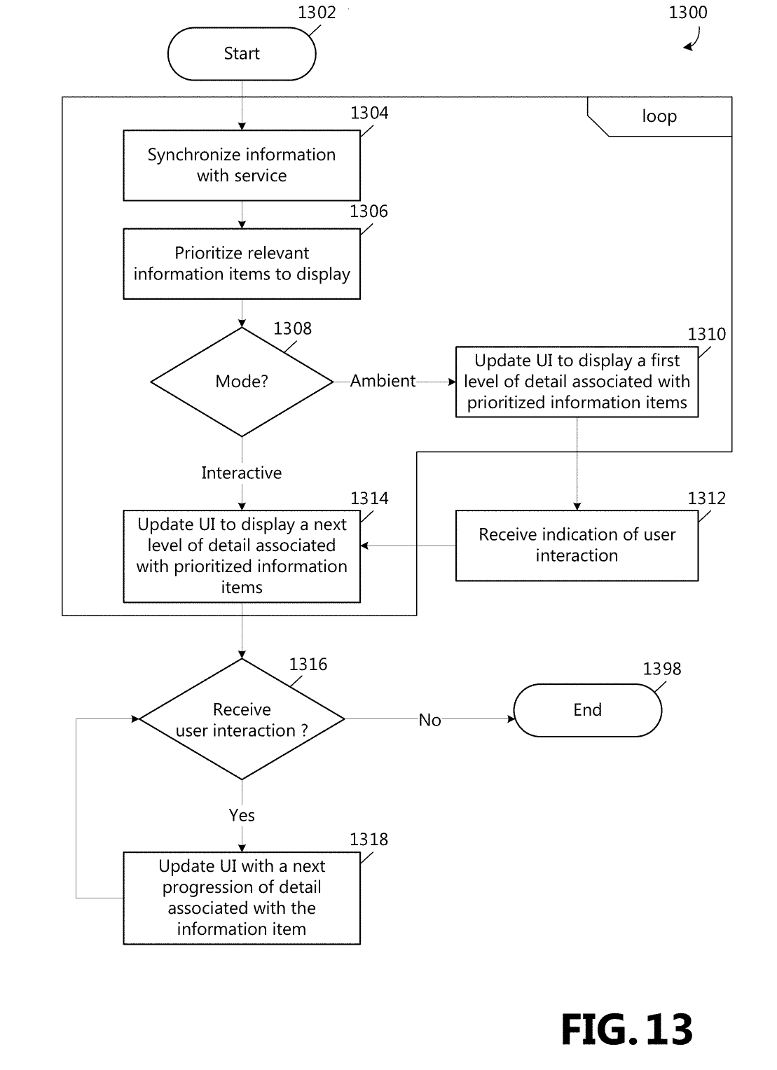

Having described an example operating environment and various example user interface displays 128, FIG. 13 is a flowchart showing general stages involved in an example method 1300 for generating a glanceable, interactive user interface for displaying prioritized relevant information. Method 1300 begins at OPERATION 1302, and proceeds to OPERATION 1304, where the glanceable information manager 110 synchronizes information 112 with one or more application services 104. For example, the glanceable information manager 110 receives information 112 associated with one or more of: upcoming events on one or more of the user's calendars; incoming communications; and current weather conditions and a weather forecast for a specified location.

The method 1300 proceeds to OPERATION 1306, where the glanceable information manager 110 prioritizes one or more relevant information items to arrange in an abbreviated format in the user interface display 128 for glanceable viewing. In some examples, prioritization of one or more relevant information items includes prioritization of one or more information items for which to display additional details in a central region 202 of the user interface display 128. According to examples, prioritization may be based on state data 118, user preference data 116, and/or other factors such as: according to which of the user's calendars the event is received (e.g., a work calendar versus a personal calendar); according to a type of event (e.g., work event versus personal event); according to an importance level associated with the event, for example, as applied in the user's or the meeting organizer's calendar; according to whether the event is a full-day event versus a shorter-duration event (e.g., a birthday marked on the user's calendar versus a meeting); according to whether the user has accepted a meeting request associated with the meeting; based on whether the user 126 has attended a same event in the past; and based on the user's location.

The method 1300 proceeds to DECISION OPERATION 1308, where a determination is made as to an operation mode of the computing device 102. When a determination is made that the operation mode of the computing device 102 is an ambient mode, the method 1300 proceeds to OPERATION 1310, where the user interface 122 generates a user interface display 128 including a rest state user interface display 128 including a first level of detail associated with the prioritized information items, and displays the user interface display 128 on a screen of the computing device 102. In some examples, a rest state may be associated with an ambient or sleep mode, where there may be little to no interaction with the computing device 102. A rest state may include a minimal amount of high level information. An example of a rest state user interface display 128 is illustrated in FIGS. 2A and 2B.

The method 1300 continues to OPERATION 1312, where an indication of user interaction is received, for example, a user interaction that “wakes” the device, such as the user 126 touching the device screen, the user 126 raising his/her wrist, a selection of a hardware button, etc. The method 1300 proceeds from OPERATION 1312 or from DECISION OPERATION 1308 upon a determination that the computing device 102 is in an interactive mode to OPERATION 1314, where the user interface 122 updates the user interface display to a first interactive state, such as the example interactive state display 300 illustrated in FIG. 3. According to an example, the first interactive state includes a display of additional relevant information, such as one or more of: a graphical indication of which of the user's calendars that an upcoming event 208 is associated, information associated with the next upcoming event 304, and the current weather 302. According to an aspect, OPERATIONS 1304-1314 reoccur in a loop.

The method 1300 proceeds to DECISION OPERATION 1316, where a determination is made as to whether a user interaction is received, such as a user input 402 on or near an information item displayed on the user interface display 128, or a selection of a functionality (e.g., hardware button, soft key) to show additional information item detail. In other examples, user input 402 may include voice input, a gesture, or other input method. An example of a user input 402 associated with a selection of an information item displayed on the user interface display 128 for displaying additional details is illustrated in FIG. 4.

When a positive determination is made at DECISION OPERATION 1316, the method 1300 proceeds to OPERATION 1318, where the user interface 122 updates the user interface display 128 with a next progression of details associated with the selected information item or with a default information item. For example, as illustrated in FIGS. 5 and 6, the user interface 122 receives additional information from the glanceable information manager 110, such as additional event/meeting details (e.g., attendees, organizer, agenda, location details), additional communications details (e.g., senders of communications, content of communications), additional weather information (e.g., weather forecast for a specified time scale 212), etc., and updates the user interface display 128 with the additional information or a portion of the additional information according to a determined priority.

The method 1300 returns to DECISION OPERATION 1316. When a negative determination is made (e.g., no user interaction is received), the method 1300 ends at OPERATION 1398.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 14-16 and the associated descriptions provide a discussion of a variety of operating environments in which examples are practiced. However, the devices and systems illustrated and discussed with respect to FIGS. 14-16 are for purposes of example and illustration and are not limiting of a vast number of computing device configurations that are utilized for practicing aspects, described herein.

FIG. 14 is a block diagram illustrating physical components (i.e., hardware) of a computing device 1400 with which examples of the present disclosure may be practiced. In a basic configuration, the computing device 1400 includes at least one processing unit 1402 and a system memory 1404. According to an aspect, depending on the configuration and type of computing device, the system memory 1404 comprises, but is not limited to, volatile storage (e.g., random access memory), non-volatile storage (e.g., read-only memory), flash memory, or any combination of such memories. According to an aspect, the system memory 1404 includes an operating system 1405 and one or more program modules 1406 suitable for running software applications 1450. According to an aspect, the system memory 1404 includes an glanceable information manager 110, operative to enable a software application 1450 to employ the teachings of the present disclosure via stored instructions. The operating system 1405, for example, is suitable for controlling the operation of the computing device 1400. Furthermore, aspects are practiced in conjunction with a graphics library, other operating systems, or any other application program, and is not limited to any particular application or system. This basic configuration is illustrated in FIG. 14 by those components within a dashed line 1408. According to an aspect, the computing device 1400 has additional features or functionality. For example, according to an aspect, the computing device 1400 includes additional data storage devices (removable and/or non-removable) such as, for example, magnetic disks, optical disks, or tape. Such additional storage is illustrated in FIG. 14 by a removable storage device 1409 and a non-removable storage device 1410.

As stated above, according to an aspect, a number of program modules and data files are stored in the system memory 1404. While executing on the processing unit 1402, the program modules 1406 (e.g., glanceable information manager 110) perform processes including, but not limited to, one or more of the stages of the method 1300 illustrated in FIG. 13. According to an aspect, other program modules are used in accordance with examples and include applications such as electronic mail and contacts applications, word processing applications, spreadsheet applications, database applications, slide presentation applications, drawing or computer-aided application programs, etc.s

According to an aspect, the computing device 1400 has one or more input device(s) 1412 such as a keyboard, a mouse, a pen, a sound input device, a touch input device, etc. The output device(s) 1414 such as a display, speakers, a printer, etc. are also included according to an aspect. The aforementioned devices are examples and others may be used. According to an aspect, the computing device 1400 includes one or more communication connections 1416 allowing communications with other computing devices 1418. Examples of suitable communication connections 1416 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 1404, the removable storage device 1409, and the non-removable storage device 1410 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1400. According to an aspect, any such computer storage media is part of the computing device 1400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

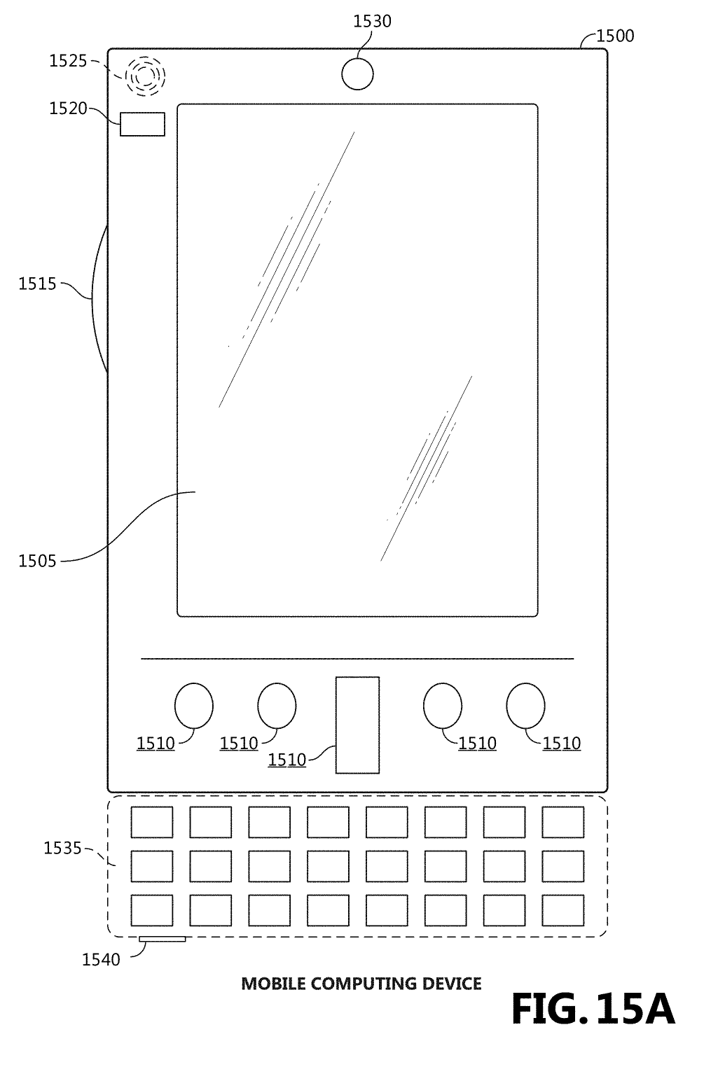

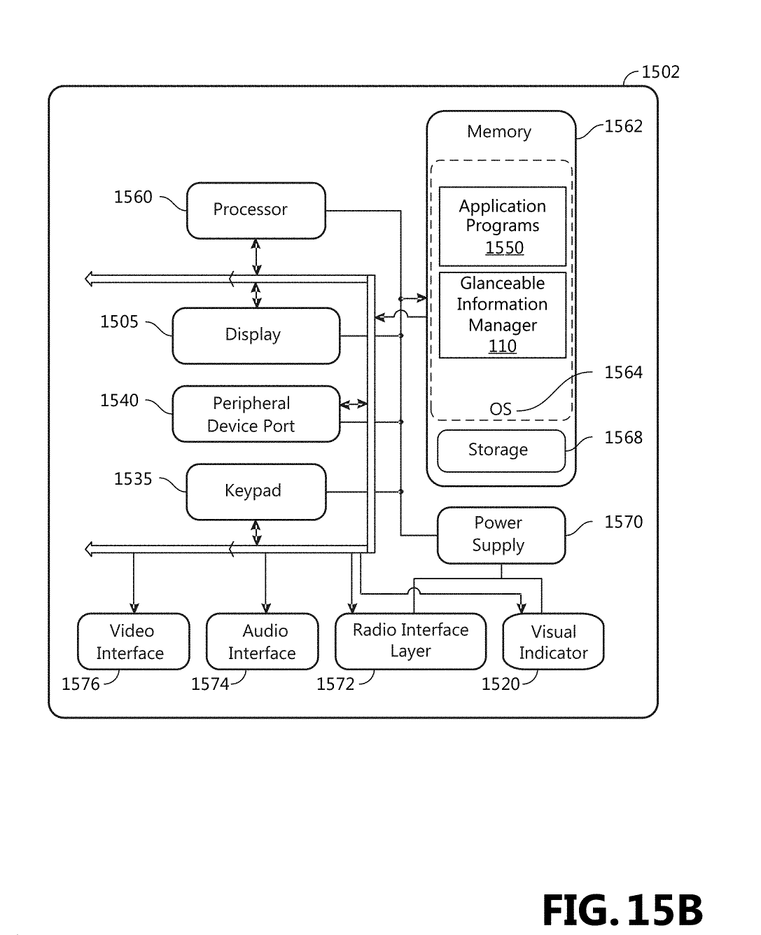

FIGS. 15A and 15B illustrate a mobile computing device 1500, for example, a mobile telephone, a smart phone, a tablet personal computer, a laptop computer, and the like, with which aspects may be practiced. With reference to FIG. 15A, an example of a mobile computing device 1500 for implementing the aspects is illustrated. In a basic configuration, the mobile computing device 1500 is a handheld computer having both input elements and output elements. The mobile computing device 1500 typically includes a display 1505 and one or more input buttons 1510 that allow the user to enter information into the mobile computing device 1500. According to an aspect, the display 1505 of the mobile computing device 1500 functions as an input device (e.g., a touch screen display). If included, an optional side input element 1515 allows further user input. According to an aspect, the side input element 1515 is a rotary switch, a button, or any other type of manual input element. In alternative examples, mobile computing device 1500 incorporates more or fewer input elements. For example, the display 1505 may not be a touch screen in some examples. In alternative examples, the mobile computing device 1500 is a portable phone system, such as a cellular phone. According to an aspect, the mobile computing device 1500 includes an optional keypad 1535. According to an aspect, the optional keypad 1535 is a physical keypad. According to another aspect, the optional keypad 1535 is a “soft” keypad generated on the touch screen display. In various aspects, the output elements include the display 1505 for showing a graphical user interface (GUI), a visual indicator 1520 (e.g., a light emitting diode), and/or an audio transducer 1525 (e.g., a speaker). In some examples, the mobile computing device 1500 incorporates a vibration transducer for providing the user with tactile feedback. In yet another example, the mobile computing device 1500 incorporates a peripheral device port 1540, such as an audio input (e.g., a microphone jack), an audio output (e.g., a headphone jack), and a video output (e.g., a HDMI port) for sending signals to or receiving signals from an external device.

FIG. 15B is a block diagram illustrating the architecture of one example of a mobile computing device. That is, the mobile computing device 1500 incorporates a system (i.e., an architecture) 1502 to implement some examples. In one example, the system 1502 is implemented as a “smart phone” capable of running one or more applications (e.g., browser, e-mail, calendaring, contact managers, messaging clients, games, and media clients/players). In some examples, the system 1502 is integrated as a computing device, such as an integrated personal digital assistant (PDA) and wireless phone.

According to an aspect, one or more application programs 1550 are loaded into the memory 1562 and run on or in association with the operating system 1564. Examples of the application programs include phone dialer programs, e-mail programs, personal information management (PIM) programs, word processing programs, spreadsheet programs, Internet browser programs, messaging programs, and so forth. According to an aspect, the glanceable information manager 110 is loaded into memory 1562. The system 1502 also includes a non-volatile storage area 1568 within the memory 1562. The non-volatile storage area 1568 is used to store persistent information that should not be lost if the system 1502 is powered down. The application programs 1550 may use and store information in the non-volatile storage area 1568, such as e-mail or other messages used by an e-mail application, and the like. A synchronization application (not shown) also resides on the system 1502 and is programmed to interact with a corresponding synchronization application resident on a host computer to keep the information stored in the non-volatile storage area 1568 synchronized with corresponding information stored at the host computer. As should be appreciated, other applications may be loaded into the memory 1562 and run on the mobile computing device 1500.

According to an aspect, the system 1502 has a power supply 1570, which is implemented as one or more batteries. According to an aspect, the power supply 1570 further includes an external power source, such as an AC adapter or a powered docking cradle that supplements or recharges the batteries.

According to an aspect, the system 1502 includes a radio 1572 that performs the function of transmitting and receiving radio frequency communications. The radio 1572 facilitates wireless connectivity between the system 1502 and the “outside world,” via a communications carrier or service provider. Transmissions to and from the radio 1572 are conducted under control of the operating system 1564. In other words, communications received by the radio 1572 may be disseminated to the application programs 1550 via the operating system 1564, and vice versa.

According to an aspect, the visual indicator 1520 is used to provide visual notifications and/or an audio interface 1574 is used for producing audible notifications via the audio transducer 1525. In the illustrated example, the visual indicator 1520 is a light emitting diode (LED) and the audio transducer 1525 is a speaker. These devices may be directly coupled to the power supply 1570 so that when activated, they remain on for a duration dictated by the notification mechanism even though the processor 1560 and other components might shut down for conserving battery power. The LED may be programmed to remain on indefinitely until the user takes action to indicate the powered-on status of the device. The audio interface 1574 is used to provide audible signals to and receive audible signals from the user. For example, in addition to being coupled to the audio transducer 1525, the audio interface 1574 may also be coupled to a microphone to receive audible input, such as to facilitate a telephone conversation. According to an aspect, the system 1502 further includes a video interface 1576 that enables an operation of an on-board camera 1530 to record still images, video stream, and the like.

According to an aspect, a mobile computing device 1500 implementing the system 1502 has additional features or functionality. For example, the mobile computing device 1500 includes additional data storage devices (removable and/or non-removable) such as, magnetic disks, optical disks, or tape. Such additional storage is illustrated in FIG. 15B by the non-volatile storage area 1568.

According to an aspect, data/information generated or captured by the mobile computing device 1500 and stored via the system 1502 are stored locally on the mobile computing device 1500, as described above. According to another aspect, the data are stored on any number of storage media that are accessible by the device via the radio 1572 or via a wired connection between the mobile computing device 1500 and a separate computing device associated with the mobile computing device 1500, for example, a server computer in a distributed computing network, such as the Internet. As should be appreciated, such data/information are accessible via the mobile computing device 1500 via the radio 1572 or via a distributed computing network. Similarly, according to an aspect, such data/information are readily transferred between computing devices for storage and use according to well-known data/information transfer and storage means, including electronic mail and collaborative data/information sharing systems.

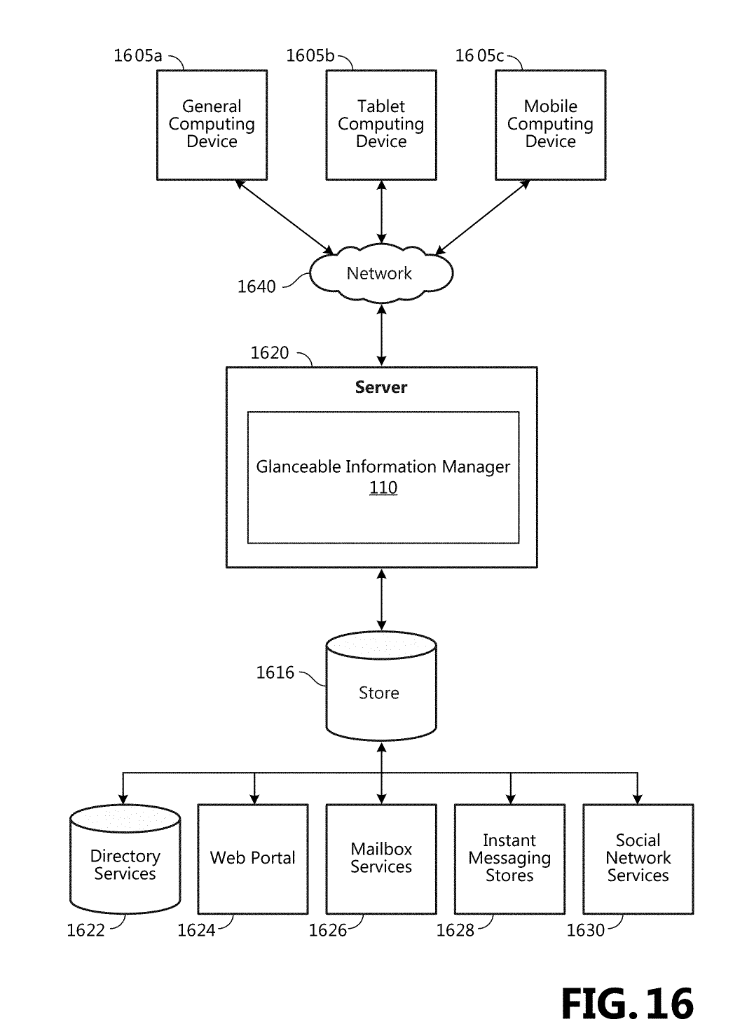

FIG. 16 illustrates one example of the architecture of a system for automatic presentation of blocks of repeated content as described above. Content developed, interacted with, or edited in association with the glanceable information manager 110 is enabled to be stored in different communication channels or other storage types. For example, various documents may be stored using a directory service 1622, a web portal 1624, a mailbox service 1626, an instant messaging store 1628, or a social networking site 1630. The glanceable information manager 110 is operative to use any of these types of systems or the like for generating a glanceable, interactive user interface for displaying prioritized relevant information, as described herein. According to an aspect, a server 1620 provides the glanceable information manager 110 to clients 1605a-c (generally clients 1605). As one example, the server 1620 is a web server providing the glanceable information manager 110 over the web. The server 1620 provides the glanceable information manager 110 over the web to clients 1605 through a network 1640. By way of example, the client computing device is implemented and embodied in a personal computer 1605a, a tablet computing device 1605b or a mobile computing device 1605c (e.g., a smart phone), or other computing device. Any of these examples of the client computing device are operable to obtain content from the store 1616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

1. A method for improving user interaction efficiency on a computing device providing a glanceable, interactive user interface display, comprising:
receiving incoming information from one or more application services, wherein the incoming information includes information relevant to a user;
prioritizing the incoming information for determining one or more information items to include in the glanceable, interactive user interface display;
generating the glanceable, interactive user interface display including a first level of detail associated with the one or more prioritized information items; and
displaying the glanceable, interactive user interface display on a screen of the computing device.

2. The method of claim 1, wherein prioritizing the incoming information for determining the one or more information items to include in the glanceable, interactive user interface display comprises prioritizing the incoming information based on at least one of:
user preference data; and
state data.

3. The method of claim 2, wherein prioritizing the incoming information for determining the one or more information items to include in the glanceable, interactive user interface display comprises prioritizing the incoming information based on a group consisting of:
a calendar from which an information item is received;
whether the information item is associated with work or is personal;
an importance level associated with the information item;
a duration of the information item, wherein the information item is an event;
whether the user has accepted a request associated with the information item; and
a location of the user.

4. The method of claim 1, wherein including a first level of detail associated with the one or more prioritized information items comprises including at least one of:
a current time;
a current date;
current weather;
an incoming communication count;
an overview of one or more upcoming events within a predetermined time scale; and
an amount of time until the next upcoming event.

5. The method of claim 4, wherein displaying the glanceable, interactive user interface display comprises displaying the overview of one or more upcoming events as arcs circumferentially positioned along the predetermined time scale, wherein a beginning point of an arc is representative of a start time of an upcoming event, an ending point of the arc is representative of an end time of the upcoming event, and an arc length is representative of a duration of the upcoming event.

6. The method of claim 5, wherein displaying the glanceable, interactive user interface display comprises differentiating the one or more upcoming events according to a calendar from which the upcoming events are received.

7. The method of claim 5, wherein displaying the glanceable, interactive user interface display comprises displaying the predetermined time scale as one of:
a 12 hour time scale;
an 18 hour time scale; and
a 24 hour time scale.

8. The method of claim 1, further comprising:
receiving an indication of a user interaction associated with an information item; and
in response to the user interaction, updating the glanceable, interactive user interface display with a first progression of detail associated with the information item.

9. The method of claim 8, further comprising:
recurringly receiving a user interaction associated with the information item; and
progressively updating the glanceable, interactive user interface display with a next progression of detail associated with the information item.

10. The method of claim 9, wherein progressively updating the glanceable, interactive user interface display with a next progression of detail associated with the information item comprises displaying a next progression of detail associated with an upcoming event, the next progression of detail selected from a group consisting of:
a meeting organizer;
meeting attendees;
a meeting agenda;
a meeting location address; and
a map showing the meeting location address.

11. The method of claim 9, wherein progressively updating the glanceable, interactive user interface display with a next progression of detail associated with the information item comprises displaying a next progression of detail associated with incoming communications, the next progression of detail selected from a group consisting of:
a sender of the incoming communication; and
contents of the incoming communication, wherein the incoming communication is an email, a text message, a voice message, a video message, or a photo message.

12. The method of claim 9, wherein progressively updating the glanceable, interactive user interface display with a next progression of detail associated with the information item comprises displaying a next progression of detail associated with weather, the next progression of detail selected from a group consisting of:
a temporal-based weather forecast;
a radar map; and
sunrise or sunset information.

13. The method of claim 12, wherein displaying the temporal-based weather forecast comprises displaying a weather forecast for a time interval, wherein an upcoming event is scheduled to occur during the time interval.

14. A computing device for improving user interaction efficiency on a computing device providing a glanceable, interactive user interface display, comprising:
a processing unit; and
a memory, including computer readable instructions, which when executed by the processing unit is operable to:
receive incoming information from one or more application services, wherein the incoming information includes information relevant to a user;
prioritize the incoming information for determining one or more information items to include in the glanceable, interactive user interface display;
generate the glanceable, interactive user interface display including a first level of detail associated with the one or more prioritized information items; and
display the glanceable, interactive user interface display on a screen of the computing device.

15. The computing device of claim 14, wherein in prioritizing the incoming information, the processing unit is operative to prioritize the incoming information based on a group consisting of:
a calendar from which an information item is received;
whether the information item is associated with work or is personal;
an importance level associated with the information item;
a duration of the information item, wherein the information item is an event;
whether the user has accepted a request associated with the information item;
a location of the user;
user preferences; and
state data, the state data including a current time.

16. The computing device of claim 14, wherein the first level of detail associated with the one or more prioritized information items is selected from a group consisting of:
a current time;
a current date;
current weather;
an incoming communication count;
an overview of one or more upcoming events within a predetermined time scale; and
an amount of time until the next upcoming event.

17. The computing device of claim 16, wherein in displaying the overview of one or more upcoming events, the processing unit is operative to:
display the one or more upcoming events as arcs circumferentially positioned along the predetermined time scale, wherein a beginning point of the arc is representative of a start time of an upcoming event, an ending point of the arc is representative of an end time of the upcoming event, and an arc length is representative of a duration of the upcoming event; and
differentiate the upcoming event from the one or more upcoming events according to a calendar from which the upcoming event is received.

18. The computing device of claim 14, wherein the processing unit if further operative to:
receive an indication of a user interaction associated with an information item;
in response to the user interaction, update the glanceable, interactive user interface display with a first progression of detail associated with the information item;
recurringly receive a user interaction associated with the information item; and
progressively update the glanceable, interactive user interface display with a next progression of detail associated with the information item.

19. The computing device of claim 18, wherein:
when the information item is an upcoming event, the processing unit is operative to display a next progression of detail associated with the upcoming event, the next progression of detail selected from a group consisting of:
a meeting organizer;
meeting attendees;
a meeting agenda;
a meeting location address; and
a map showing the meeting location address;
when the information item is associated with an incoming communication, the processing unit is operative to display a next progression of detail associated with the incoming communication, the next progression of detail selected from a group consisting of:
a sender of the incoming communication; and
contents of the incoming communication, wherein the incoming communication is an email, a text message, a voice message, a video message, or a photo message; and
when the information item is associated with weather, the processing unit is operative to display a next progression of detail associated with the weather, the next progression of detail selected from a group consisting of:
a temporal-based weather forecast;
a radar map; and
sunrise or sunset information.

20. A computer readable storage device including computer readable instructions, which when executed by a processing unit is operable to:
receive incoming information from one or more application services, wherein the incoming information includes information relevant to a user;
prioritize the incoming information for determining one or more information items to include in a glanceable, interactive user interface display;
generate the glanceable, interactive user interface display including a first level of detail associated with the one or more prioritized information items;
display the glanceable, interactive user interface display on a screen of a computing device;
receive an indication of a user interaction associated with an information item;
in response to the user interaction, update the glanceable, interactive user interface display with a first progression of detail associated with the information item;
recurringly receive a user interaction associated with the information item; and
progressively update the glanceable, interactive user interface display with a next progression of detail associated with the information item.
